(19) United States
(12) Patent Application Publication
(10) Pub. No.: US 2026/0199072 A1
(43) Pub. Date: Jul. 16, 2026

(54) LOW-NOISE INFUSION PUMP AND AUTOMATED INFUSION SYSTEM USING THE SAME

(71) Applicants: INCHEON NATIONAL UNIVERSITY RESEARCH & BUSINESS FOUNDATION, Incheon (KR); MPATCHIA INC., Incheon (KR)

(72) Inventors: Sung Hun JIN, Seongnam-si (KR); Hyeon-Bin JO, Incheon (KR)

(21) Appl. No.: 19/444,734

(22) Filed: Jan. 9, 2026

(30) Foreign Application Priority Data
Jan. 10, 2025 (KR) 10-2025-0004047

(51) Int. Cl. A61D 7/00

(52) U.S. Cl. CPC A61D 7/00

(57) ABSTRACT

Provided is a low-noise infusion pump and an automated infusion system using the same, including: a wearable infusion bag device configured to be worn on an animal and to inject a fluid into a body of the animal, the wearable infusion bag device including a low-noise infusion pump operated by a low-noise driving motor; an in-body insertion sensing unit inserted into the body and configured to collect biological data; and an infusion control unit configured to control operation of the low-noise infusion pump based on operation data of the low-noise infusion pump and the biological data received from the low-noise infusion pump and the in-body insertion sensing unit via wireless communication.

### CROSS-REFERENCE TO RELATED APPLICATION

This application claims priority to Korean Patent Application No. 10-2025-0004047 filed on January 10, 2025, and all the benefits accruing therefrom under 35 U.S.C. §119, the contents of which are incorporated herein by reference in their entirety.

### BACKGROUND OF THE DISCLOSURE

### Field of the Disclosure

The present disclosure relates to a low-noise infusion pump and an automated infusion system using the same. In particular, the present disclosure relates to a low-noise infusion pump capable of automatically supplying an infusion to livestock sensitive to noise and to an automated infusion system using the same, which allows remote monitoring of an infusion state and adjustment of an infusion amount.

### Description of the Related Art

In recent years, rapid development has been made in the livestock industry with respect to infusion devices for administering fluids to livestock.

However, conventional infusion devices are mainly used in hospitals and generate a high level of noise during operation. Accordingly, when such conventional infusion devices are applied to livestock that are sensitive to noise, such as cattle or horses, stress caused by noise may be induced, which may lead to deterioration of the livestock’s condition. In addition, livestock may refuse or resist fluid infusion by the infusion device, thereby causing a risk of injury to administrators or veterinarians.

In particular, in the case of livestock in a critical condition immediately after childbirth, fluids essential for life support must be supplied in a stable manner. However, conventional infusion devices have difficulty in stably supplying fluids to livestock due to noise generation.

Furthermore, livestock such as cattle and horses require a larger amount of fluid to be infused compared to humans, and thus continuous fluid supply is often required not only during the daytime but also during nighttime.

However, since conventional infusion devices require administrators or veterinarians to remain near the animal while administering fluids, there is a problem in that it is difficult to stably infuse fluids during nighttime when it is difficult for administrators or veterinarians to stay on site.

### Related Patent Document

Korean Registered Patent Publication No. 10-1970412

Korean Laid-Open Patent Publication No. 10-2016-0053322

Korean Laid-Open Patent Publication No. 10-2018-0095316

Korean Laid-Open Patent Publication No. 10-2024-0045481

### SUMMARY OF THE DISCLOSURE

In order to solve the above-described problems of the related art, a purpose of the present disclosure is to provide a low-noise infusion pump and an automated infusion system using the same, which collect biological data of livestock requiring fluid infusion by using a multimodal sensor inserted into the body of the livestock, automatically infuse fluids into the livestock through a wearable infusion bag device including the low-noise infusion pump based on the collected biological data, and monitor an infusion state to adjust an infusion amount and an infusion rate according to the health condition of the livestock.

In order to achieve the above purposes, an aspect of the present disclosure provides an automated infusion system using a low-noise infusion pump, comprising:

a wearable infusion bag device configured to be worn on an animal and to inject a fluid into a body of the animal, the wearable infusion bag device including a low-noise infusion pump operated by a low-noise driving motor;

an in-body insertion sensing unit inserted into the body and configured to collect biological data; and

an infusion control unit configured to control operation of the low-noise infusion pump based on operation data of the low-noise infusion pump and the biological data received from the low-noise infusion pump and the in-body insertion sensing unit via wireless communication.

In some exemplary embodiments, the low-noise infusion pump may comprise:

a one-way control valve configured to control a fluid introduced into the low-noise infusion pump to flow in a single direction;

a syringe through which an infusion fluid is supplied via the one-way control valve and injected into the body; and

a driving motor configured to control operation of the one-way control valve and the syringe at low noise using a DC motor.

In some exemplary embodiments, the low-noise infusion pump may comprise:

a valve control motor connected to the one-way control valve and configured to control operation of the one-way control valve; and

a syringe control motor configured to pressurize a plunger of the syringe to control operation of the syringe.

In some exemplary embodiments, the low-noise infusion pump may further comprise:

a power transmission unit configured to convert rotational power of the driving motor into linear power and to transmit the linear power to the syringe.

In some exemplary embodiments, when the infusion fluid is charged into the syringe, the low-noise infusion pump may rotate a valve core of the one-way control valve upward to block an infusion injection passage, and

when the infusion fluid charged in the syringe is injected into the body, the low-noise infusion pump may rotate the valve core of the one-way control valve downward to block an infusion supply passage.

In some exemplary embodiments, the low-noise infusion pump may further comprise:

a pump power unit including a detachable and rechargeable lithium-ion battery; and

a pump control unit configured to regulate a voltage input from the pump power unit and supply the regulated voltage to the driving motor, and to control operation of the driving motor having a wireless communication module via wireless communication.

In some exemplary embodiments, the wearable infusion bag device may form a fixed space and may be configured to mount the low-noise infusion pump and an infusion bag within the fixed space.

In some exemplary embodiments, the in-body insertion sensing unit may be inserted into a subcutaneous fat layer of the body and may be configured to collect biological data including at least one of body temperature, heart rate, or blood pressure.

In some exemplary embodiments, the infusion control unit may be configured to monitor an infusion amount or an infusion rate of a fluid based on operation data of the low-noise infusion pump received from the low-noise infusion pump having a wireless communication module, and to transmit an operation signal to the low-noise infusion pump to adjust the infusion amount or the infusion rate.

In some exemplary embodiments, the infusion control unit may be configured to monitor an infusion state.

When an abnormal state including interruption of infusion or excessive infusion occurs, the infusion control unit may transmit a notification message to a mobile terminal of a user or an administrator.

Specific details of other exemplary embodiments are included in "Details for carrying out the invention" and accompanying "drawings".

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, by using a low-noise infusion pump, noise generated during an infusion process for an animal can be reduced, thereby reducing stress caused by noise, stabilizing the animal, and enabling infusion to be performed in a stable and reliable manner.

In addition, according to the present disclosure, based on biological data of livestock measured using a multimodal sensor inserted into a body of the livestock and operation data of the low-noise infusion pump, an infusion amount or an infusion rate of a fluid injected into the livestock can be monitored, the fluid can be automatically infused, as well as the infusion amount and the infusion rate can be remotely controlled.

### BRIEF DESCRIPTION OF THE DRAWINGS

FIG. 1 is a diagram illustrating an automated infusion system using a low-noise infusion pump according to an exemplary embodiment of the present disclosure.

FIG. 2 is a diagram illustrating an actual operation state of the automated infusion system equipped with the low-noise infusion pump according to an exemplary embodiment of the present disclosure.

FIG. 3 is an enlarged view illustrating a wearable infusion bag device equipped with the low-noise infusion pump according to an exemplary embodiment of the present disclosure.

FIG. 4 is a diagram illustrating a configuration of the low-noise infusion pump according to an exemplary embodiment of the present disclosure.

FIG. 5 is an exploded perspective view illustrating the low-noise infusion pump according to an exemplary embodiment of the present disclosure.

FIG. 6 is a diagram illustrating a frame of the low-noise infusion pump according to an exemplary embodiment of the present disclosure.

FIG. 7 is an exploded view illustrating components of the low-noise infusion pump according to an exemplary embodiment of the present disclosure.

FIG. 8 is a view illustrating assembled components of a low-noise infusion pump according to an exemplary embodiment of the present disclosure.

FIG. 9 is a view illustrating operation of the low-noise infusion pump according to an exemplary embodiment of the present disclosure.

FIG. 10 is a view illustrating operation of a syringe and a one-way control valve according to an exemplary embodiment of the present disclosure.

FIG. 11 is a view illustrating operation of a syringe and a one-way control valve according to another exemplary embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component "includes" another component, it does not exclude any other component, but may further include any other component unless otherwise indicated.

Furthermore, it should be noted that when it is described that a component "exists in or is connected to" another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is "directly connected to" or "directly accesses" to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as "one side surface", "other side surface", "one side", "other side", "first", "second", etc., are used in this specification, the terms are used to clearly distinguish one component from the other component and a meaning of the corresponding component is not limited used by the terms.

Further, in this specification, if terms related to locations such as "upper", "lower", "left", "right", etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Moreover, one or more “unit” and/or “module” described in this specification can be implemented via a non-transitory memory (not shown) and a processor (not shown). The memory is configured to store data concerning algorithms designed to control the operation of system components according to exemplary embodiments of the present disclosure, or software instructions that implement these algorithms. The processor is configured to perform the operations described below using the data stored in the memory. Here, the memory and the processor may be implemented as separate chips. Alternatively, the memory and the processor may be implemented as a single integrated chip. The processor may take the form of one or more processors.

Furthermore, in the specification of the present disclosure, terms such as “unit,” “device,” “module,” and “apparatus,” if used, refer to a unit capable of processing one or more functions or operations and should be understood to be implementable in hardware, software, or a combination of hardware and software.

As will be understood by those skilled in the art, the realization of all or some of the steps of the above exemplary embodiments may be accomplished through hardware, or may be accomplished by directing the relevant hardware through a computer program. The computer program may include instructions for executing some or all of the steps of the method, the computer program may be stored on a readable storage medium, and the storage medium may be any form of storage medium.

Hereinafter, exemplary embodiments of the present disclosure will be described in detail with reference to related drawings.

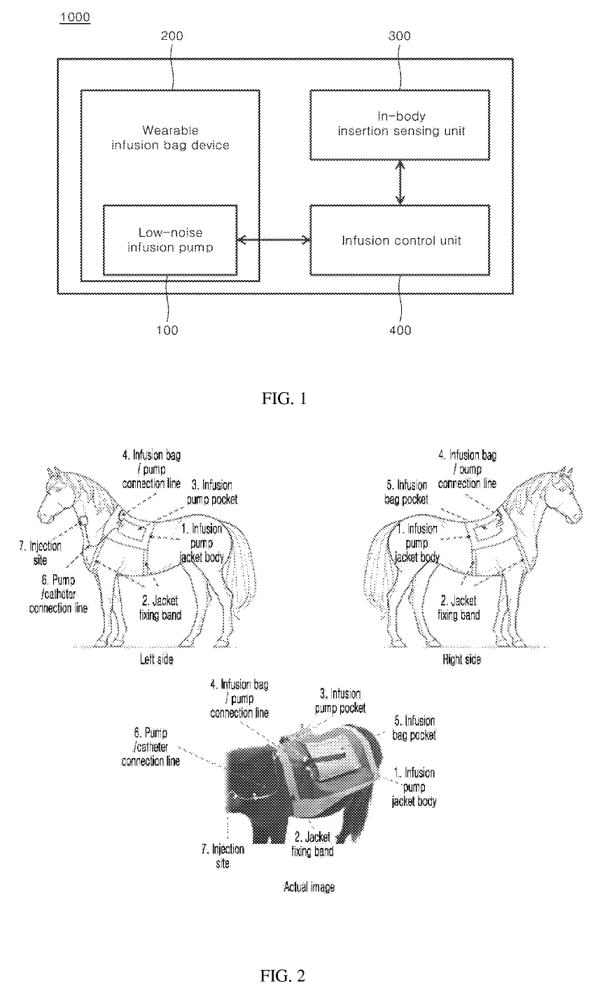

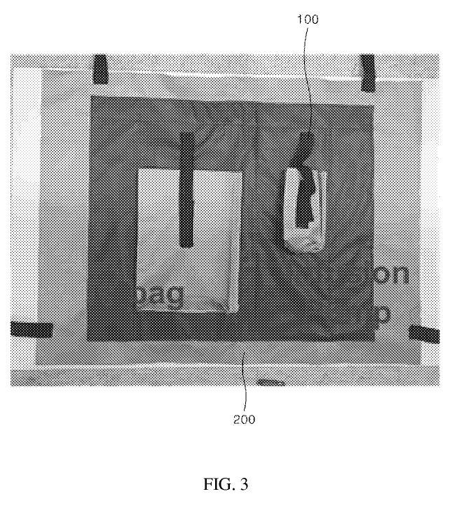

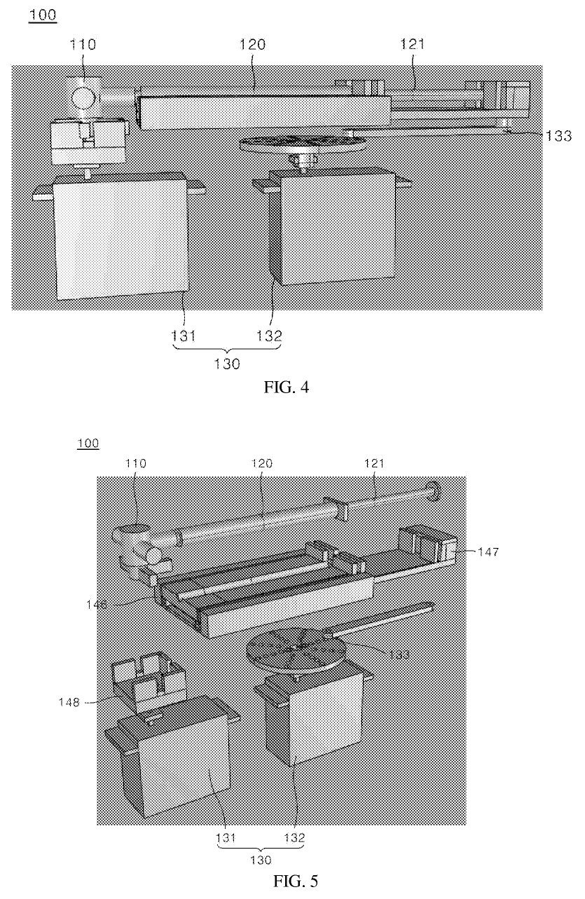

FIG. 1 is a diagram illustrating an automated infusion system using a low-noise infusion pump according to an exemplary embodiment of the present disclosure; FIG. 2 is a diagram illustrating an actual operation state of the automated infusion system equipped with the low-noise infusion pump according to an exemplary embodiment of the present disclosure; and FIG. 3 is an enlarged view illustrating a wearable infusion bag device equipped with the low-noise infusion pump according to an exemplary embodiment of the present disclosure.

As used herein, the term low-noise infusion pump means a low-acoustic-noise infusion pump that reduces a level of mechanical noise or physical noise generated during operation of the pump.

As shown in FIG. 1, an automated infusion system 1000 using a low-noise infusion pump according to an exemplary embodiment of the present disclosure may include a wearable infusion bag device 200, an in-body insertion sensing unit 300, and an infusion control unit 400.

Here, the wearable infusion bag device 200 according to an exemplary embodiment of the present disclosure may include a low-noise infusion pump 100 operated by a low-noise driving motor, and may operate while being worn on an animal, thereby allowing an infusion fluid in an infusion bag to be injected into a body of the animal through the low-noise infusion pump 100.

Specifically, the wearable infusion bag device 200 according to an exemplary embodiment of the present disclosure may be formed in the form of a wearable jacket so as to be worn by the animal, and a fixed space may be formed in the wearable jacket, such that the low-noise infusion pump 100 and the infusion bag are mounted in the fixed space.

Referring to FIGS. 2 to 3, a wearable infusion bag device 200 according to an exemplary embodiment of the present disclosure includes a low-noise infusion pump 100 and an infusion bag mounted in a fixed space formed in a wearable jacket, and operates the low-noise infusion pump 100 connected to the infusion bag to inject an infusion fluid stored in the infusion bag into a body through an insertion unit (for example, an injection needle) connected to the low-noise infusion pump 100.

For example, as illustrated in FIG. 2, the wearable infusion bag device 200 may include a low-noise infusion pump pocket and an infusion bag pocket, and may be formed in a jacket type.

Here, the low-noise infusion pump 100 may be fixed in the low-noise infusion pump pocket, and the infusion bag may be fixed in the infusion bag pocket.

In addition, the wearable infusion bag device 200 may further include a jacket fixing band so as to be closely attached to and fixed on a body of an animal.

When the wearable infusion bag device 200 according to an exemplary embodiment of the present disclosure is worn on the body of the animal, the infusion fluid in the infusion bag may move to the low-noise infusion pump 100 along an infusion bag–infusion pump connection line by operation of the low-noise infusion pump 100.

Thereafter, the infusion fluid moved from the infusion bag to the low-noise infusion pump 100 may be injected into the body of the animal through an injection site along a pump–catheter connection line by operation of the low-noise infusion pump 100.

Here, the infusion bag–infusion pump connection line and the pump–catheter connection line may be installed in the wearable infusion bag device 200 so as not to contact each other.

Accordingly, the wearable infusion bag device 200 according to an exemplary embodiment of the present disclosure can prevent entanglement of infusion connection lines connected between the infusion bag, the low-noise infusion pump 100, and the injection site, and also prevent separation of the infusion connection lines, thereby enabling stable injection of the infusion fluid into the body of the animal regardless of movement of the animal.

Through this, unlike a conventional method of injecting an infusion fluid into the body of an animal using gravity, the wearable infusion bag device 200 according to an exemplary embodiment of the present disclosure can exhibit an effect of injecting the infusion fluid into the body of the animal using the low-noise infusion pump 100 even without positioning the infusion bag higher than a heart position of the animal into which the infusion fluid is injected.

The low-noise infusion pump 100 provided in the wearable infusion bag device 200 according to an exemplary embodiment of the present disclosure includes a wireless communication module, and may transmit operation data of a driving motor 130 that operates at low noise to the infusion control unit 400 via wireless communication.

Here, the wireless communication module may use a wireless communication technology including Bluetooth, Wi-Fi, NFC (Near Field Communication), Zigbee, Z-Wave, LoRa (Long Range), Sigfox, a cellular network, Wi-SUN (Wireless Smart Utility Network), NB-IoT (Narrowband IoT), and LTE-M (LTE Cat-M1).

The in-body insertion sensing unit 300 according to an exemplary embodiment of the present disclosure may be inserted into a body and may collect biological data.

Specifically, the in-body insertion sensing unit 300 according to an exemplary embodiment of the present disclosure may be inserted into a subcutaneous fat layer of the body to collect biological data including body temperature, respiratory rate, heart rate, or blood pressure.

For example, since the in-body insertion sensing unit 300 is inserted into the subcutaneous fat layer of an animal instead of a conventional animal body temperature measurement method in which a thermometer is inserted into a rectum of the animal to directly measure body temperature, a risk of infection caused by animal excrement can be prevented.

In addition, the in-body insertion sensing unit 300 according to an exemplary embodiment of the present disclosure includes a wireless communication module, and may transmit the biological data collected while being inserted into the body to the infusion control unit 400 through wireless communication.

Here, the wireless communication module may perform wireless communication using a wireless communication technology including Bluetooth, Wi-Fi, NFC (Near Field Communication), Zigbee, Z-Wave, LoRa (Long Range), Sigfox, a cellular network, Wi-SUN (Wireless Smart Utility Network), NB-IoT (Narrowband IoT), and LTE-M (LTE Cat-M1).

That is, the automated infusion system using the low-noise infusion pump 1000 according to an exemplary embodiment of the present disclosure may insert, into the body of an animal, the in-body insertion sensing unit 300 designed by integrating a plurality of sensors including a temperature sensor, an electrochemical sensor, a pressure sensor, or a pH sensor.

Through this, the automated infusion system using the low-noise infusion pump 1000 according to an exemplary embodiment of the present disclosure can monitor, in real time, an abnormal state of the animal such as an increase in body temperature or oxygen deficiency, and can monitor changes in a health state of the animal caused by the infused fluid.

In addition, the automated infusion system using the low-noise infusion pump 1000 according to an exemplary embodiment of the present disclosure has an effect of adjusting whether to administer an infusion to the animal, an infusion amount, and an infusion rate based on the monitored health state.

The infusion control unit 400 according to an exemplary embodiment of the present disclosure may control operation of the low-noise infusion pump 100 based on operation data of a driving motor and biological data received from the low-noise infusion pump 100 and the in-body insertion sensing unit 300 through wireless communication.

For example, the infusion control unit 400 according to an exemplary embodiment of the present disclosure may monitor an infusion amount or an infusion rate of a fluid based on operation data of the low-noise infusion pump received from the low-noise infusion pump 100, and may transmit an operation signal to the low-noise infusion pump 100 to control the low-noise infusion pump 100, thereby adjusting the infusion amount or the infusion rate of the fluid according to operation of the low-noise infusion pump 100.

Here, the operation data of the low-noise infusion pump 100 may include operation data of the driving motor 130 of the low-noise infusion pump 100.

Specifically, the infusion control unit 400 according to an exemplary embodiment of the present disclosure may measure and monitor the infusion amount of the fluid injected or the infusion rate at which the fluid is injected according to operation of the driving motor 130 included in the low-noise infusion pump 100.

In addition, the infusion control unit 400 according to an exemplary embodiment of the present disclosure may transmit an operation signal for the driving motor 130 to the pump control unit 160 included in the low-noise infusion pump 100 to control the driving motor 130, thereby adjusting the infusion amount or the infusion rate of the fluid.

In addition, the infusion control unit 400 according to an exemplary embodiment of the present disclosure may monitor an infusion state, and when an abnormal state including interruption of infusion or excessive infusion occurs, may transmit a notification message to a mobile terminal of a user or an administrator.

For example, the infusion control unit 400 according to an exemplary embodiment of the present disclosure may determine whether an abnormal state including interruption of infusion, excessive infusion, battery shortage of the low-noise infusion pump 100, or blockage of an infusion connection line has occurred by using operation data of the low-noise infusion pump received from the low-noise infusion pump 100 and biological data received from the in-body insertion sensing unit 300.

Here, when it is determined that an abnormal state has occurred during infusion to an animal, the infusion control unit 400 according to an exemplary embodiment of the present disclosure may transmit a notification message to a mobile terminal of a user or an administrator, or may control the mobile terminal of the user or the administrator to generate a notification sound or vibration.

In summary, in the automated infusion system using the low-noise infusion pump 1000 according to an exemplary embodiment of the present disclosure, a wearable infusion bag device including an infusion bag and a low-noise infusion pump is worn on an animal, and the in-body insertion sensing unit 300 is inserted into the body of the animal to collect biological data.

Accordingly, by using the automated infusion system using the low-noise infusion pump 1000 according to an exemplary embodiment of the present disclosure, infusion fluid stored in the infusion bag can be automatically injected into the body of the animal without a separate administrator or veterinarian staying nearby and directly administering the infusion.

In addition, by monitoring an infusion amount or an infusion rate of the fluid according to operation of the low-noise infusion pump 100 and biological data according to operation of the in-body insertion sensing unit 300, an administrator or veterinarian can remotely adjust the infusion amount or the infusion rate of the fluid injected into the body of the animal using a mobile terminal device according to a health state of the animal.

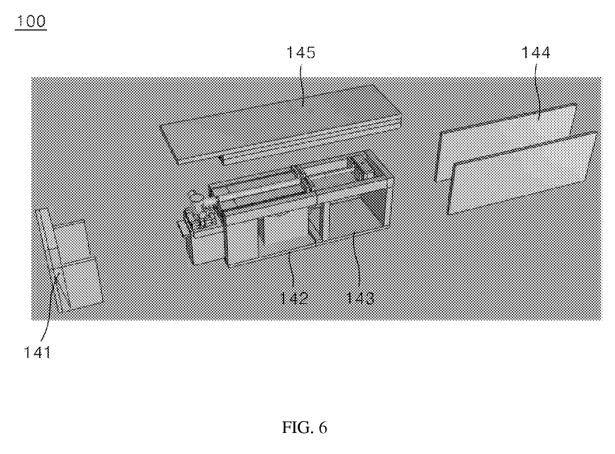

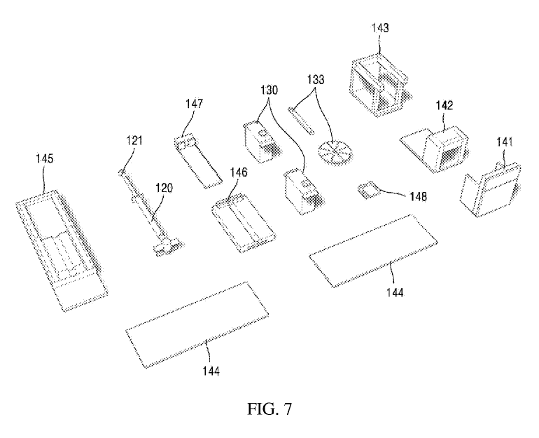

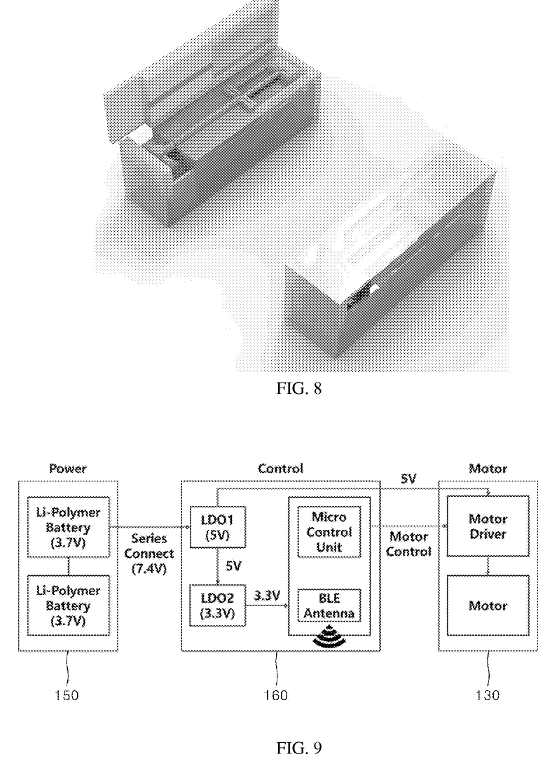

FIG. 4 is a diagram illustrating a configuration of the low-noise infusion pump according to an exemplary embodiment of the present disclosure; FIG. 5 is an exploded perspective view illustrating the low-noise infusion pump according to an exemplary embodiment of the present disclosure; FIG. 6 is a diagram illustrating a frame of the low-noise infusion pump according to an exemplary embodiment of the present disclosure; FIG. 7 is an exploded view illustrating components of the low-noise infusion pump according to an exemplary embodiment of the present disclosure; FIG. 8 is a view illustrating assembled components of a low-noise infusion pump according to an exemplary embodiment of the present disclosure; and FIG. 9 is a view illustrating operation of the low-noise infusion pump according to an exemplary embodiment of the present disclosure.

Referring to FIGS. 4 to 9, the low-noise infusion pump 100 according to an exemplary embodiment of the present disclosure may include a one-way control valve 110, a syringe 120, and a driving motor 130.

The one-way control valve 110 according to an exemplary embodiment of the present disclosure may control a fluid introduced into the pump to flow in a single direction.

Preferably, the one-way control valve 110 according to an exemplary embodiment of the present disclosure may be formed as a three-way valve to control the fluid introduced into the pump to flow in a single direction.

Here, the three-way valve may include three connection ports (for example, an inlet and outlets), and may include a valve core mounted inside the valve to block or switch a flow of the fluid introduced into the valve.

In addition, the three-way valve may be operated manually, electrically, or pneumatically; however, in the present disclosure, it is preferable that the three-way valve is operated using the driving motor 130.

Specifically, the one-way control valve 110 according to an exemplary embodiment of the present disclosure may operate such that infusion fluid from an infusion bag flows into and is charged in the syringe 120 by changing a position of the valve core mounted inside the valve to open an infusion supply passage, which refers to a passage through which the infusion bag and an interior of the syringe 120 are connected.

The syringe 120 according to an exemplary embodiment of the present disclosure may receive infusion fluid supplied through the one-way control valve 110 and may inject the supplied infusion fluid into a body.

Here, the syringe 120 may be operated using the driving motor 130.

Specifically, in the syringe 120 according to an exemplary embodiment of the present disclosure, when a plunger 121 of the syringe 120 is pressurized by the driving motor 130 and moves rearward, and the one-way control valve 110 opens the infusion supply passage by the driving motor 130, infusion fluid may be introduced from an infusion connection line.

On the other hand, when the plunger 121 moves forward by the driving motor, and the one-way control valve 110 opens an infusion injection passage, which refers to a passage through which an insertion unit and the interior of the syringe 120 are connected, by the driving motor 130, the infusion fluid introduced into the interior of the syringe 120 may be injected into the body by being delivered to an infusion connection line connected to the body of the animal.

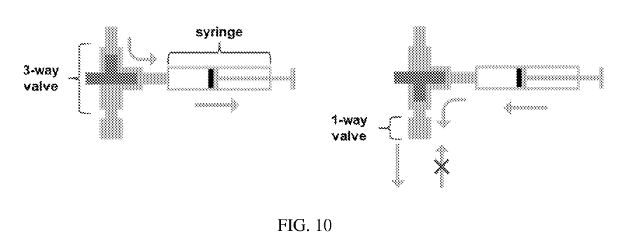

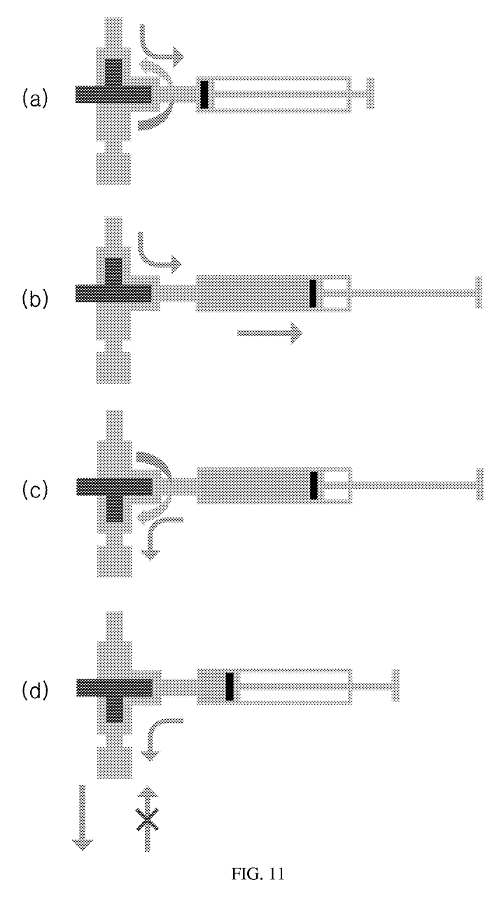

A description of the one-way control valve 110 and the syringe 120 according to an exemplary embodiment of the present disclosure will be described in more detail in the description related to FIGS. 10 to 11.

The driving motor 130 according to an exemplary embodiment of the present disclosure may control operation of the one-way control valve 110 and the syringe 120 at low noise by using a DC motor.

For example, it is preferable that the driving motor 130 according to an exemplary embodiment of the present disclosure uses a brushless DC motor formed in a structure without brushes and a commutator to reduce friction and noise.

Specifically, the driving motor 130 according to an exemplary embodiment of the present disclosure may include a valve control motor 131 and a syringe control motor 132.

The valve control motor 131 according to an exemplary embodiment of the present disclosure may be connected to the one-way control valve 110 to control operation of the one-way control valve.

Specifically, the valve control motor 131 according to an exemplary embodiment of the present disclosure may rotate a valve core mounted inside the one-way control valve 110 to change a flow and a direction of a fluid flowing inside the one-way control valve 110.

In addition, the syringe control motor 132 according to an exemplary embodiment of the present disclosure may pressurize the plunger 121 of the syringe 120 to control operation of the syringe 120.

As illustrated in FIGS. 4 to 7, the syringe control motor 132 according to an exemplary embodiment of the present disclosure may further include a power transmission unit 133 configured to convert rotational power of the driving motor into linear power and transmit the linear power to the plunger 121 of the syringe 120.

For example, the power transmission unit 133 according to an exemplary embodiment of the present disclosure may include a single circular disk and a rectangular rod connected to the circular disk.

Accordingly, in the power transmission unit 133 according to an exemplary embodiment of the present disclosure, one end may be connected to the syringe control motor 132 and the other end may be connected to the plunger 121 of the syringe 120, such that, when the circular disk is rotated by the syringe control motor 132, the rectangular rod connected to the circular disk moves forward and rearward, thereby allowing linear power to be transmitted to the plunger 121 by the rectangular rod.

That is, since rotational power of the syringe control motor 132 is converted into linear power by operation of the power transmission unit 133 according to an exemplary embodiment of the present disclosure, the syringe control motor 132 may pressurize the plunger 121 of the syringe 120 connected to the power transmission unit 133.

The low-noise infusion pump 100 according to an exemplary embodiment of the present disclosure may further include a pump frame 140.

As illustrated in FIGS. 4 to 8, the pump frame 140 according to an exemplary embodiment of the present disclosure may include a front pump frame 141, a central pump frame 142, a rear pump frame 143, a side pump frame 144, an upper pump frame 145, a syringe fixing frame 146, a plunger fixing frame 147, and a valve fixing frame 148.

By including the pump frame 140, the low-noise infusion pump 100 according to an exemplary embodiment of the present disclosure may fix and protect the one-way control valve 110, the syringe 120, and the driving motor 130 included in the low-noise infusion pump 100.

In addition, the low-noise infusion pump 100 according to an exemplary embodiment of the present disclosure may further include a pump power unit 150 and a pump control unit 160.

Referring to FIG. 9, the pump power unit 150 according to an exemplary embodiment of the present disclosure may include a detachable and rechargeable lithium-ion battery.

Specifically, the pump power unit 150 according to an exemplary embodiment of the present disclosure may connect two detachable and rechargeable 3.7 V lithium-ion batteries in series, and may supply an input voltage of 7.4 V to the pump control unit 160 through the connected lithium-ion batteries.

The pump control unit 160 according to an exemplary embodiment of the present disclosure may regulate a voltage input from the pump power unit 150 and supply the regulated voltage to the driving motor 130, and may control operation of the driving motor 130 having a wireless communication module by using wireless communication.

Specifically, the pump control unit 160 according to an exemplary embodiment of the present disclosure may include a low dropout regulator (LDO) to step down the voltage input from the pump power unit 150.

Accordingly, the pump control unit 160 may step down the input voltage of 7.4 V to 5 V through a first low dropout regulator (LDO 1), and may supply the stepped-down 5 V voltage to the driving motor 130 and a second low dropout regulator (LDO 2).

Thereafter, the pump control unit 160 may use the second low dropout regulator to step down the input voltage of 5 V supplied from the first low dropout regulator to 3.3 V, and may supply the stepped-down voltage to a microcontroller (MCU) of the pump control unit 160 and a wireless communication module (for example, a Bluetooth module) to operate the same.

The microcontroller of the pump control unit 160 according to an exemplary embodiment of the present disclosure may receive operation data of the driving motor 130 through the provided wireless communication module, and may transmit the received operation data of the driving motor 130 to the infusion control unit 400 of the automated infusion system using the low-noise infusion pump 1000.

In addition, the pump control unit 160 according to an exemplary embodiment of the present disclosure may receive an operation signal for the driving motor 130 from the infusion control unit 400 of the automated infusion system using the low-noise infusion pump 1000, and may transmit the received operation signal to the driving motor 130 to control operation of the driving motor 130.

Accordingly, the driving motor 130 may control the valve control motor 131 or the syringe control motor 132 according to the operation signal received from the pump control unit 160.

FIG. 10 is a view illustrating operation of a syringe and a one-way control valve according to an exemplary embodiment of the present disclosure; and FIG. 11 is a view illustrating operation of a syringe and a one-way control valve according to another exemplary embodiment of the present disclosure.

Referring to FIGS. 10 to 11, the low-noise infusion pump 100 according to an exemplary embodiment of the present disclosure, as illustrated in FIG. 11a, when a fluid is charged into the syringe 120, may rotate a valve core of the one-way control valve 110 upward to open a fluid supply passage and block a fluid injection passage.

Accordingly, as illustrated in FIG. 11b, within the one-way control valve 110, a fluid (for example, an infusion fluid) flows from an upper portion of the one-way control valve 110 connected to an infusion bag toward an interior of the syringe 120 through the fluid supply passage, such that the infusion fluid of the infusion bag may be charged into the syringe 120.

In addition, the low-noise infusion pump 100 according to an exemplary embodiment of the present disclosure, as illustrated in FIG. 11c, when injecting the fluid charged in the syringe 120 into the body, may rotate the valve core of the one-way control valve 110 downward to open the fluid injection passage and block the fluid supply passage.

Accordingly, as illustrated in FIG. 11d, within the one-way control valve 110, the fluid flows from the interior of the syringe 120 toward a lower portion of the one-way control valve 110 connected to the insertion unit 210 through the fluid injection passage, such that the fluid charged in the syringe 120 may be injected into the body of the animal.

Here, the fluid within the one-way control valve 110 flowing toward the insertion unit flows in one direction by passing through a one-way valve, and thus flows toward a direction in which the insertion unit is positioned.

That is, blood within the body cannot pass through the one-way control valve 110.

Accordingly, the low-noise infusion pump 100 according to an exemplary embodiment of the present disclosure may prevent blood within the body from flowing backward into the syringe 120.

As a result, the automated infusion system 1000 including the low-noise infusion pump 100 according to an exemplary embodiment of the present disclosure prevents blood of the animal from flowing backward into the low-noise infusion pump 100 even when the infusion bag is positioned below a body (for example, a torso) of the animal due to movement of the animal, thereby enabling stable infusion of the fluid into the animal.

In the above, although several preferred embodiments of the present disclosure have been described with some examples, the descriptions of various exemplary embodiments described in the "Specific Content for Carrying Out the Invention" item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### List of Reference numbers

100 : low-noise infusion pump

110 : one-way control valve

120 : syringe

121 : plunger

130 : driving motor

131 : valve control motor

132 : syringe control motor

133 : power transmission unit

140 : pump frame

141 : front pump frame

142 : central pump frame

143 : rear pump frame

144 : side pump frame

145 : upper pump frame

146 : syringe fixing frame

147 : plunger fixing frame

148 : valve fixing frame

150 : pump power unit

160 : pump control unit

200 : wearable infusion bag device

210 : insertion unit

300 : in-body insertion sensing unit

400 : infusion control unit

1000 : automated infusion system using the low-noise infusion pump

What is claimed is:

1. An automated infusion system using a low-noise infusion pump, comprising:
a wearable infusion bag device configured to be worn on an animal and to inject a fluid into a body of the animal, the wearable infusion bag device including a low-noise infusion pump operated by a low-noise driving motor;
an in-body insertion sensing unit inserted into the body and configured to collect biological data; and
an infusion control unit configured to control operation of the low-noise infusion pump based on operation data of the low-noise infusion pump and the biological data received from the low-noise infusion pump and the in-body insertion sensing unit via wireless communication.

2. The automated infusion system of claim 1,
wherein the low-noise infusion pump comprises:
a one-way control valve configured to control a fluid introduced into the low-noise infusion pump to flow in a single direction;
a syringe through which an infusion fluid is supplied via the one-way control valve and injected into the body; and
a driving motor configured to control operation of the one-way control valve and the syringe at low noise using a DC motor.

3. The automated infusion system of claim 2,
wherein the low-noise infusion pump comprises:
a valve control motor connected to the one-way control valve and configured to control operation of the one-way control valve; and
a syringe control motor configured to pressurize a plunger of the syringe to control operation of the syringe.

4. The automated infusion system of claim 2,
wherein the low-noise infusion pump further comprises:
a power transmission unit configured to convert rotational power of the driving motor into linear power and to transmit the linear power to the syringe.

5. The automated infusion system of claim 2,
wherein, when the infusion fluid is charged into the syringe, the low-noise infusion pump rotates a valve core of the one-way control valve upward to block an infusion injection passage, and
when the infusion fluid charged in the syringe is injected into the body, the low-noise infusion pump rotates the valve core of the one-way control valve downward to block an infusion supply passage.

6. The automated infusion system of claim 1,
wherein the low-noise infusion pump further comprises:
a pump power unit including a detachable and rechargeable lithium-ion battery; and
a pump control unit configured to regulate a voltage input from the pump power unit and supply the regulated voltage to the driving motor, and to control operation of the driving motor having a wireless communication module via wireless communication.

7. The automated infusion system of claim 1,
wherein the wearable infusion bag device forms a fixed space and is configured to mount the low-noise infusion pump and an infusion bag within the fixed space.

8. The automated infusion system of claim 1,
wherein the in-body insertion sensing unit is inserted into a subcutaneous fat layer of the body and is configured to collect biological data including at least one of body temperature, heart rate, or blood pressure.

9. The automated infusion system of claim 1,
wherein the infusion control unit is configured to monitor an infusion amount or an infusion rate of a fluid based on operation data of the low-noise infusion pump received from the low-noise infusion pump having a wireless communication module, and to transmit an operation signal to the low-noise infusion pump to adjust the infusion amount or the infusion rate.

10. The automated infusion system of claim 1,
wherein the infusion control unit is configured to monitor an infusion state and,
when an abnormal state including interruption of infusion or excessive infusion occurs, to transmit a notification message to a mobile terminal of a user or an administrator.
